(19) United States
(12) Patent Application Publication
(10) Pub. No.: US 2007/0169973 A1
(43) Pub. Date: Jul. 26, 2007

(54) Two-wheel vehicle with integral wheel-drive

(75) Inventors: Lucio Masut, Pisa (IT); Mario Donato Santucci, Lucca (IT)

Correspondence Address: HEDMAN & COSTIGAN P.C., 1185 AVENUE OF THE AMERICAS, NEW YORK, NY, 10036, US

(73) Assignee: Piaggio & C. S. p.A, Pisa (IT)

(21) Appl. No.: 11/653,719

(22) Filed: Jan. 16, 2007

(30) Foreign Application Priority Data
Jan. 25, 2006 (IT) MI 2006A 000111

(51) Int. Cl. B60K 1/00

(52) U.S. Cl. 180/65.5; 180/220

(57) ABSTRACT

Two-wheel vehicle (10) with an integral electric wheel-drive characterized in that it comprises two electric driving motors, a front wheel electric motor (11) and a back wheel electric motor (12) respectively, fed by at least one electric accumulator group.

The present invention relates to a two-wheel vehicle with an integral electric wheel-drive.

Various types of two-wheel vehicles with an electric wheel-drive are currently available on the market, all characterized in that the electric motor is applied directly on the back wheel on which its driving action is exerted (wheel-drive).

It is known that, depending on the position of the wheel-drive with respect to the vehicle, the transfer of weights and consequently the balancing of the vehicle, especially when accelerating and braking, takes place in different ways.

Whereas, in fact, in acceleration the weight shifts towards the rear part of the vehicle, when braking the contrary occurs. This means that in a front wheel-drive vehicle, in the acceleration phase, the front part tends to rise with a consequent lightening of the driving wheels (or the driving wheel in the case of a two-wheel vehicle), which are generally also guiding wheels, with the result that, especially for increasing accelerations or on slippery surfaces, the wheels can lose their adherence and the vehicle can swerve towards the outside of the bend.

In a vehicle with a back-wheel drive, on the contrary (as in the case of two-wheel vehicles, in particular mopeds and motorcycles, with both traditional and electric wheel-drive) the problems of roadholding on bends are the opposite, i.e. following a strong acceleration or even a softer acceleration but immediately following previous braking (with the load that has shifted to the front part of the vehicle), the vehicle may tend to swerve in the rear part, pushing the vehicle towards the inside of the bend. Furthermore, in the case of braking, as the weight has shifted to the front part of the vehicle, the braking action of the engine is limited.

In view of what is specified above, there is evidently the necessity of availing of a two-wheel vehicle with an integral wheel-drive, and consequently being able, as is already the case with four-wheel vehicles with an integral wheel-drive, to avoid problems relating to weight distribution and roadholding as mentioned above.

A two-wheel vehicle of this type however must overcome a series of production problems, as, due to the different structure of the frame, it is not possible to transfer to the moped and motorcycle field the engine drive expedients that are adopted in the case of integral wheel-drive automobiles.

An objective of the present invention is therefore to solve the problems of the known art by providing a two-wheel vehicle with an integral electric wheel-drive equipped with an electric motor for each wheel, capable of providing the maximum wheel-drive in complete safety on any surface and with an excellent front and rear weight distribution.

A further objective of the present invention is to provide a two-wheel vehicle with an integral electric wheel-drive having extreme structural and functional simplicity. These and other objectives are achieved by the two-wheel vehicle with an integral electric wheel-drive according to the present invention, which has the characteristics of claim 1 enclosed.

Further characteristics and advantages of the present invention will appear more evident from the present description, provided for illustrative and non-limiting purposes, with reference to the enclosed drawings, in which:

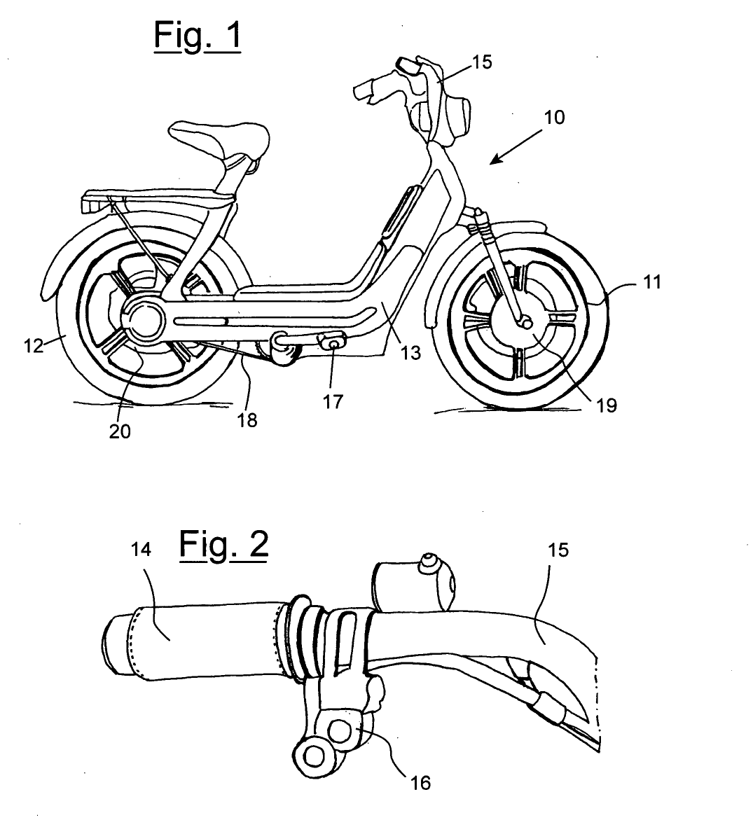

FIG. 1 shows a side view of a two-wheel vehicle with an integral electric wheel-drive, in particular a moped, according to the present invention;

FIG. 2 shows a perspective view of one of the grips of the driving handlebars of the moped of figure 1, close to which a wheel-drive selector is applied; and

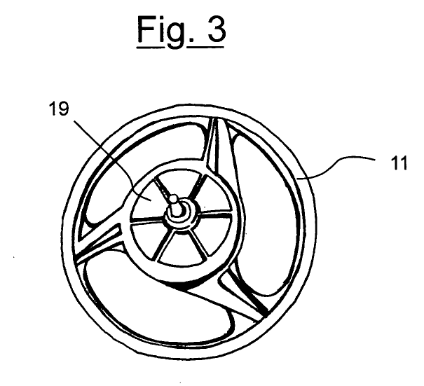

FIG. 3 shows a view of a wheel of the moped of FIG. 1.

With reference to the figures, these show a two-wheel vehicle with an integral electric wheel-drive according to the present invention, in particular a moped, indicated as a whole with 10.

The two-wheel vehicle 10 with an integral electric wheel-drive consists of two electric motor groups installed in the front wheel hub 11 and in the back wheel hub 12, respectively. The two motors are fed by an electric accumulator group, housed inside the frame 13 of the two-wheel vehicle 10, and which has the characteristic of being able to be extracted to allow transportation and recharging “at home”. Alternatively, the recharging can be effected without the extraction of the accumulator, i.e. “on site”, by means of a battery-charger installed on board, also housed inside the frame 13 and equipped with a wire with a plug for connection to the electric supply or, more generally, to an electric power source.

The electric motor drive can be supplied according to two different modes. Firstly by means of a handle accelerator situated on one of the grips 14 of the driving handlebars 15 and a suitable transducer (HALL effect probe, potentiometer, or other types of known transducers).

The wheel-drive mode can be suitably selected on the basis of the demands and requirements of the driver: by means of an appropriate switch selector 16 it is possible to pass from an integral wheel-drive (activation of the back wheel 12 and front wheel 11 both active), to a back wheel-drive alone (only the activation of the back wheel 12), to a front wheel-drive alone (only the activation of the front wheel 11). In the case of the version with a double active motor, moped performances are reached (40 km/h).

In the case of back wheel-drive alone, the electric motor drive is transmitted by means of the functioning of “assisted pedaling” (25 km/h), whereby part of the energy transmitted to the back wheel 12 is provided through a direct action on the pedals 17 and transmitted through the chain 18. A torque sensor consequently activates the rear motor which assists the pedaling.

FIGS. 1 and 3 also show how the wheels 11, 12 of the vehicle 10 of the present invention, envisage respective hubs 19, 20 having larger dimensions than those normally used, in order to allow the housing of the respective electric motors.

The selection of the wheel-drive mode depends on various factors: performances required, autonomy and hold. The triggering of the integral wheel-drive is conveniently reserved for particular driving situations which, thanks to the selector 16, can be selected by the driver of the vehicle. The wheel-drive on all the wheels generally privileges performances and motility and is always advisable under low hold conditions, but can also be established on the basis of personal considerations of the driver.

In particular, the selector 16 allows the following wheel-drive modes to be selected:

integral wheel-drive: both motors are activated, the electric wheel-drive is applied to both the front and back wheel;

back wheel-drive: the functioning of the front motor is inhibited, the electric wheel-drive is applied to the back wheel only;

front wheel-drive: the functioning of the back motor is inhibited, the electric wheel-drive is applied to the front wheel only;

assisted pedaling: the wheel-drive provided by the electric motor and that provided by the user by acting on the pedals 17, act on the back wheel.

The control of the electric wheel-drive (in its various modes), the energy flow and recharging is managed by two electronic controllers (one for each electric motor).

The vehicle 10 according to the present invention is evidently not a simple low-cost and low-value electric bicycle, but a real “electric two-wheel vehicle” which is solid, reliable, of a high-value, safe and easy to drive.

The two-wheel vehicle 10 according to the present invention not only allows typical performances of vehicles of the same type with a non-electric wheel-drive to be reached, but also guarantees the optimum control of the weight distribution in all the running modes and minimizes consumption to that required.

A further advantage provided by the two-wheel vehicle 10 with an integral wheel-drive according to the present invention is in the braking phase, as, when motors with energy recovery are used when braking, the braking action of the engine can be exploited on both the front wheel 11 and on the back wheel 12.

Finally, numerous modifications and variants can obviously be applied to the two-wheel vehicle 10 thus conceived; furthermore all the details can be substituted by technically equivalent elements. In practice, the materials used, as also the dimensions, can vary according to technical demands.

1. A two-wheel vehicle (10) with an integral electric wheel-drive characterized in that it comprises two electric driving motors, a front wheel electric motor (11) and a back wheel electric motor (12) respectively, fed by at least one electric accumulator group.

2. The two-wheel vehicle (10) with an integral electric wheel-drive according to claim 1, characterized in that each electric motor is fed by a different electric accumulator group.

3. The two-wheel vehicle (10) with an integral electric wheel-drive according to claim 1, characterized in that said electric motors are respectively housed in the hub (19) of the front wheel (11) and in the hub (20) of the back wheel (12).

4. The two-wheel vehicle (10) with an integral electric wheel-drive according to claim 1, characterized in that said at least one electric accumulator group can be extracted to allow transportation and recharging “at home”.

5. The two-wheel vehicle (10) with an integral electric wheel-drive according to claim 2, characterized in that said at least one electric accumulator group can be extracted to allow transportation and recharging “at home”.

6. The two-wheel vehicle (10) with an integral electric wheel-drive according to claim 1, characterized in that it comprises at least one battery-charger for the recharging of said at least one electric accumulator group “on site”.

7. The two-wheel vehicle (10) with an integral electric wheel-drive according to claim 2, characterized in that it comprises at least one battery-charger for the recharging of said at least one electric accumulator group “on site”.

8. The two-wheel vehicle (10) with an integral electric wheel-drive according to claim 1, characterized in that the driving of the electric motors is provided by a handle accelerator situated on one of the grips (14) of the driving handlebars (15) and is transmitted by a transducer.

9. The two-wheel vehicle (10) with an integral electric wheel-drive according to claim 1, characterized in that it comprises a selector (16) whereby the wheel-drive on both wheels (11, 12) is alternatively established, on the front wheel (11) alone or on the back wheel (12) alone.

10. The two-wheel vehicle (10) with an integral electric wheel-drive according to claim 9, characterized in that said selector (16) is situated on one of the grips (14) of the driving handlebars (15).

11. The two-wheel vehicle (10) with an integral electric wheel-drive according to claim 1, characterized in that it comprises an electronic controller for each electric motor, for controlling the electric wheel-drive, the energy flow and recharging.

12. The two-wheel vehicle (10) with an integral electric wheel-drive according to claim 1, characterized in that it comprises two pedals (17) and a chain (18) for transmission to the back wheel (12) of the motor action exerted by the user of the vehicle (10).
